(19) United States
(12) Patent Application Publication
(10) Pub. No.: US 2018/0144234 A1
(43) Pub. Date: May 24, 2018

(54) Sentence Embedding for Sequence-To-Sequence Matching in a Question-Answer System

(71) Applicant: Arturo Devesa, Brooksville, FL (US)

(72) Inventor: Arturo Devesa, Brooksville, FL (US)

(21) Appl. No.: 15/356,604

(22) Filed: Nov. 20, 2016

(51) Int. Cl. G06N 3/00; G06N 7/00; G06N 99/00; G06F 17/27

(52) U.S. Cl. CPC G06N 3/006; G06F 17/277; G06N 99/005; G06N 7/00

(57) ABSTRACT

An artificially intelligent question-answer system is disclosed. The system and method comprises of embedding a given sentence (question) into a n-dimensional vector whereby it can be compared to other known questions to determine the appropriate answer. Sentence embedding follows a weighted average of word embeddings contained in the sentence. Words can be further weighted to improve accuracy. The final sentence embedding is compared in an 1₂-norm sense and the known sentence yielding the minimum euclidean distance is chosen. The associated answer is then matched to input sentence.

### 1 TECHNICAL FIELD

This disclosure relates to machine learning and more specifically to trainable systems to producing answers to open ended questions.

### 2 DISCUSSION OF RELATED ART

This is method relies on n-dimensional word embeddings[3]. There have been many approaches to this “word-to-vec” algorithm[5, 1] with many applications in speech and NLP. The algorithm that this method uses is described in [4].

Natural language processing has also made advances in entire sentences[6]. Many of these approaches rely on Long Short-Term Memory (LSTM) architectures which are robust and well-suited for sequence-to-sequence matching. However, these architectures are complicated and are computationally cumbersome. Other approaches rely on convolutional neural networks (CNN) [2], though they are used less frequently.

### 4 SUMMARY

The present invention is a computationally fast, artificially intelligent question-answer system. The system and method comprises of a method to embed a sentence in a Eucledian space for the purpose of matching similar sentences. This method pulls a very large dataset of question-answer pairs and is able to embed each question into a vector. Comparisons can be made between the input question and the known questions. The most similar vectors will indicate a match and the answer from minimum distance question will be returned to the user. Thus, given some database of enough questions (i.e., millions of question-answer pairs), most questions in a certain field (e.g., medical, though this invention is not limited to that scope) will be able to be answered in this manner.

While much of the discussion in this patent relates to medical questions, the scope of this invention is not limited to that domain. The claims of this patent span disciplines as the technique of sentence embedding and a robust question-answer system will be applicable in any field.

### 5 BRIEF DESCRIPTION OF THE DRAWINGS

FIG. 1A description of the known question sentence embedding flow used in this system.

FIG. 2 A diagram showing the sentence to vector computation. Note, this figure shows a 2D embedding. In practice, this would be n-dimensional, though n=128 is used in this system.

FIG. 3 The user interaction flow with this system.

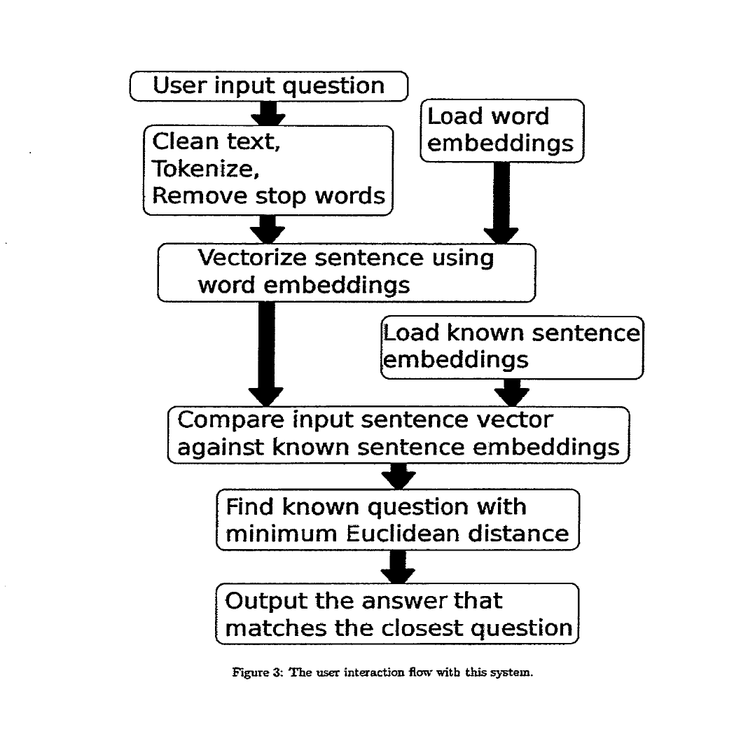

### 6 DETAILED DESCRIPTION OF DRAWINGS

6.1 Data

Two sources are used to train this model. The first is a set of known questions from curated set of known question-answer pairs. The questions and answers can be used in word embedding, Additional literature can also be used as an additional corpus for higher accuracy in word embedding. Each word is then “cleaned” by removing unnecessary stop words based on the NLTK criteria. Each word is then “tokenized” by assigning an integer to each word. Additionally, each word is assigned a weight. For the medical case, if the word appears in the NIH MedLine dictionaries, then it has a weight of 2.0. If it does not, the weight is then 1.0. Such weighting would not be limited to NIH databases. Such term-based weighting would work in any field.

6.2 Sentence Embedding

The top 100,000 words are embedded in a 128-dimensional Euclidean space. There are many approaches to this, but we use the skip gram word2vec algorithm as described in [4]. Thus, we can embed M words in an N -dimensional space (where M=100, 000 and N=128). We can then assign each word i to some vector xᵢ ∈ R^{N} where N is the length of the vector. To extend this to embedding sentences to some vector vⱼ ∈ R^{N}. This is done by doing a point-wise average vectors to create a sentence vector vⱼ.

$${}_{1}^{}{L}{}_{{v}_{j}}^{} = {}_{L}^{}{x}{}_{i}^{}$$

$$i = 1$$

Some words are more relevant to certain use cases than others. For example, in the medical case, each word is assigned some weight aᵢ ∈ {1.0, 2.0} based on the word appearing in the MedLine term list. Thus a weighted average can be computed thereby giving more weight to the medical terms. This is determined by

$$\frac{{}_{1}^{}{L}{}_{i = {1}^{{a}_{i} {x}_{i}}}^{} {v}_{j} {=}_{L} {L}_{i = {1}^{{a}_{i}}}}{2}$$

An example of this would be a sentence

How long does it take to get over a cold?

The words that would be embedded would likely be “how,” “long,” “take,” “over,” and “cold.” These are all important, but the key word here is “cold.” Thus, it might be make sense to use a weighted averaging for each word.

6.3 Answer Generation

A user inputs a sentence. This system then converts this sentence to a sentence vector v̂. The system then does a comparison against all of the other sentence vectors from the known questions. An appropriate comparison could be the 1₂-norm. This would take the form

j=argmin // v̂−vⱼ // ₂j

where j is the index corresponding to the closest matching sentence in the known question-answer pairs. The returned answer is the answer that is associated with index ⱼ.

6.4 Example Architecture

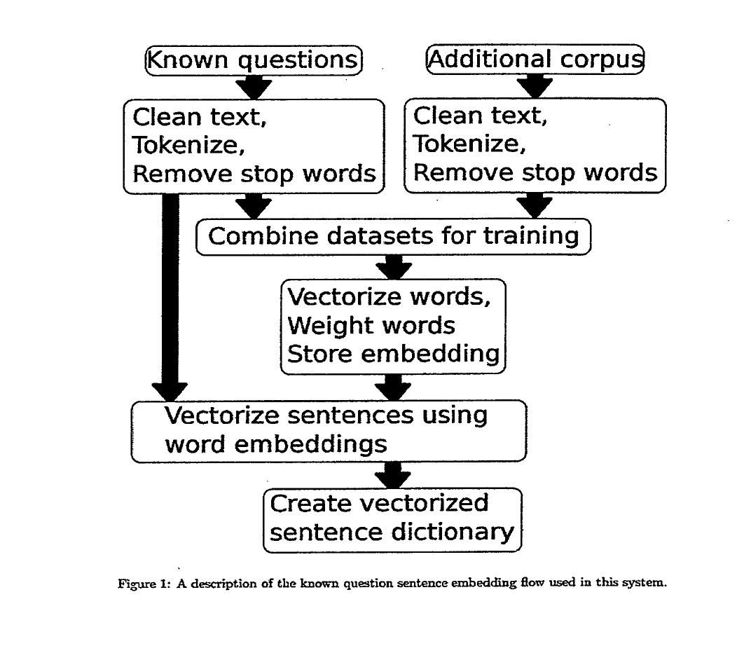

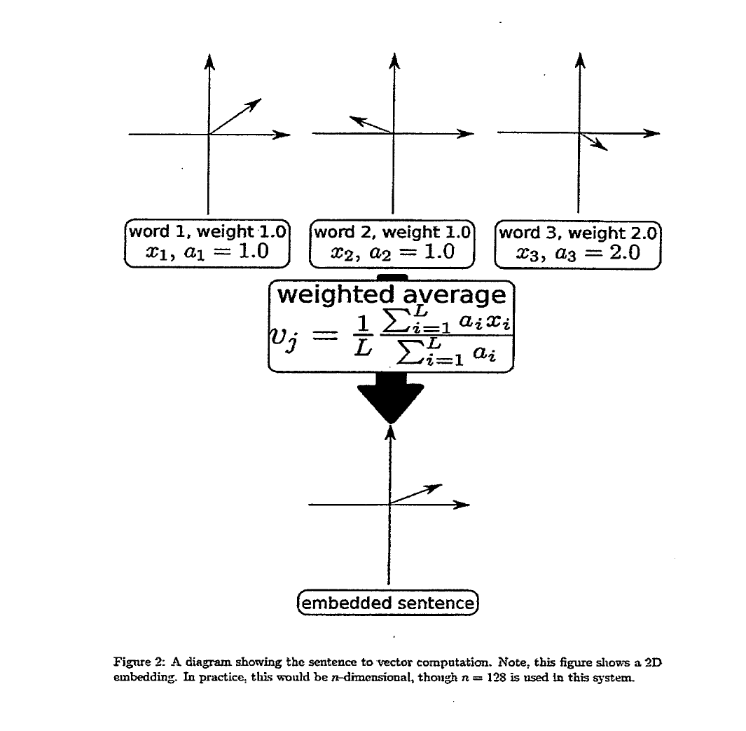

There are many variants that could be used in training this system as shown in FIG. 1 and FIG. 2. The word embedding stage of the system is the most tunable, using the skip-gram model. But this invention is not limited to using this one model as many word2vec implementations could be used similar effectiveness. The parameters used in the word2vec algorithm are given below.

|Parameter Learning Rate 1.0

Vocabulary Size |50,000 Batch Size 128 Embedding Size 128

Skip Window 1 Number of Skips 2

Table 1: Table for the word2vec hyperparameters used 6.5 User Interfacing

This model allows any question to be mapped to a known answer and presented to the user. This is done by embedding the question to a n-dimensional vector which is compared against known vectors to determine the smallest Euclidean distance. Thus, if the set of known question-answer pairs is large enough, then it is conceivable that any open-ended question should be able to be matched.

This system allows very rapid answer determination. This is a result of a pre-trained model where the known sentences are embedded into vectors a priori; the input sentence can then be quickly embedded (where the individual words are also known a priori) into a sentence for comparison. Clever use of linear algebra software packages allows the fast comparison between

$$\frac{Value}{3} \vert \vert \vert \vert \vert$$

input and known question vectors. And, with lookup complete, the answer is provided to the user. It is critical to system performance that this training is complete before user interaction. We expect the word and sentence embeddings to be computed and stored for rapid retrieval before the user engages with the system. Therefore, the time from input question to returned answer is only a few seconds.

6.6 Hyperparameter Tuning

The system as described is tunable to significantly impact performance. These hyperparameters include:

Word embedding dimensionality The number of unique words to be embedded Batch size Skip window Number of skips Assigned weight values Comparison method (i.e., the use of minimizing Euclidean distance) Number of steps in the word vectorization 6.7 System Variants

The procedure described is only variant for the overall scope of this method. Other techniques that could alter performance, though still fall within the realm of the invention, are

Altering the hyperparameters for the word2vec algorithm.

Changing the architecture of the word2vec algorithm to a different variant.

Changing the vector comparison metric to something other than Euclidean difference (e.g., using the 1₁ norm).

Changing the word weighting for the sentence embedding These are only a few examples of changes that could be applied to the system. However, changes to the system are not limited to what is described above.

### REFERENCES

[1] Y. Bengio, R. Ducharme, P. Vincent, and C. Jauvin. A neural probabilistic language model. Journal of Machine Learning Research, 3(Feb):1137-1155, 2003.

[2] N. Kalchbrenner, E. Grefenstette, and P. Blunsom. A convolutional neural network for modelling sentences. arXiv preprint arXiv:1404.2188, 2014.

[3] T. Mikolov, K. Chen, G. Corrado, and J. Dean. Efficient estimation of word representations in vector space. arXiv preprint arXiv:1301.3781, 2013.

[4] T. Mikolov, I. Sutskever, K. Chen, G. S. Corrado, and J. Dean. Distributed representations of words and phrases and their compositionality. In Advances in neural information processing systems, pages 3111-3119, 2013.

[5] D. E. Rumelhart, G. E. Hinton, and R. J. Williams. Learning representations by back-propagating errors. Cognitive modeling, 5(3):1, 1988.

[6] I. Sutskever, O. Vinyals, and Q. V. Le. Sequence to sequence learning with neural networks. In Advances in neural information processing systems, pages 3104-3112, 2014.

3.1. A computer application to embed a given section into a n-dimensional vector where it can be compared to other known questions to determine the appropriate answer.(i) Sentence embedding follows a weighted average of word embeddings contained in the sentence, (ii) Words can be further weighted to improve accuracy (iii) The final sentence embedding is compared in an 12-norm sense and the known sentence yielding the minimum euclidean distance is chosen; (iv) The associated answer is then matched to input sentence.
